(19) United States
(12) Patent Application Publication
(10) Pub. No.: US 2014/0186613 A1
(43) Pub. Date: Jul. 3, 2014

(54) ANTI-REFLECTION COATINGS WITH SELF-CLEANING PROPERTIES, SUBSTRATES INCLUDING SUCH COATINGS, AND RELATED METHODS

(71) Applicant: GUARDIAN INDUSTRIES CORP., Auburn Hills, MI (US)

(72) Inventors: Liang LIANG, Taylor, MI (US); Richard BLACKER, Farmington Hills, MI (US)

(73) Assignee: GUARDIAN INDUSTRIES CORP., Auburn Hills, MI (US)

(21) Appl. No.: 13/727,767

(22) Filed: Dec. 27, 2012

(51) Int. Cl. C09D 5/00; C03C 17/32

(52) U.S. Cl. CPC C09D 5/006; C03C 17/32
USPC 428/328; 427/162

(57) ABSTRACT

Methods of making titania coatings having self-cleaning properties, and associated articles are provided. In certain example instances, a substrate supports a layer comprising titanium dioxide. The substrate may support multiple layers. After curing, the resulting coating may reduce the occurrence of fouling.

Certain example embodiments of this invention relate to silica and titania coatings. In certain example embodiments of this invention, such coatings may be used in photovoltaic devices, antifog mirrors, storefront windows, display cases, picture frames, greenhouses, other types of windows, or in any other suitable application.

### BACKGROUND AND SUMMARY OF EXAMPLE EMBODIMENTS

Antireflective coatings may be useful for photovoltaic devices and other applications in which reflection of electromagnetic radiation is preferably avoided. Titania-based coatings may be used, although they occasionally may suffer from possible disadvantages, such as instability of coating solutions or sols.

Conventional wet chemical methods to produce titania coatings may use sol-gel processes involving hydrolysis and/or condensation reactions of titanium alkoxides. Titania coatings that are formed from these sols are generally fired at elevated temperatures to convert the precursor compounds into titanium dioxide coatings. In many instances, titania sols are aged for several hours after they are prepared in order to ensure thorough hydrolysis of precursor alkoxides.

The stability of titania sols may be affected by several factors, including pH, water content, concentration of solids, etc. Chelating ligands, such as 2,4-pentanedione may be added to titania sols so as to prolong their shelf life.

Producing stable sols in volumes required for mass production may be challenging. While the shelf life of titania sols may be influenced by storage and transportation conditions, the useful pot life during processing may be affected by the loss of volatiles, exposure to humidity (e.g., ambient humidity), etc. During thermal processing of coatings, heating profiles of gradual temperature ramp rates may be employed to promote condensation and cross-linking reactions. Coatings may be fired at high temperatures to burn off organic content and form titanium dioxide coatings.

There may be a need for a method to produce a self-cleaning anti-reflection coating that includes titania and silica. There may also be a need for a method by which titania precursor coatings may be stored and fired on demand to produce titania coatings.

Hydrophilic coatings (e.g., coatings with a low contact angle) may be useful for self-cleaning surfaces as well as in anti-fog and/or anti-mist applications. Antireflective coatings may be useful for photovoltaic devices and other applications in which reflection of electromagnetic radiation is preferably avoided.

Photovoltaic devices such as solar cells (and modules therefor) are known in the art. Glass is an integral part of most common commercial photovoltaic modules, including both crystalline and thin film types. A solar cell/module may include, for example, a photoelectric transfer film made up of one or more layers located between a pair of substrates. One or more of the substrates may be of glass, and the photoelectric transfer film (typically a semiconductor) is for converting solar energy to electricity. Example solar cells are disclosed in U.S. Pat. Nos. 4,510,344, 4,806,436, 6,506,622, 5,977,477, and JP 07-122764, the disclosures of which are hereby incorporated herein by reference.

For photovoltaic (PV) applications—that is, in applications involving photovoltaic modules—the reflection of glass is preferably minimized. The power output of the module may be dependant upon the amount of light (e.g., the number of photons) within the solar spectrum that passes through the glass and reaches the PV semiconductor. Therefore, numerous attempts have been made to try to boost overall solar transmission through glass used in PV-modules.

One attempt relates to the use of iron-free or “clear” glass, which may increase the amount of solar light transmission when compared to regular float glass, through absorption minimization. Solar transmission may be further increased by the use of an antireflective (AR) coating on the first surface of the glass. Porous silica has been used as an AR coating on a glass substrate. But AR coatings derived from porous silica may be difficult to keep clean due to the possible a presence of a large amount of pores in structure.

Therefore, there may be a need to include an antireflective coating that preferably is highly durable and/or self cleaning and/or hydrophilic and may be used as a PV superstrate or the like.

Many types of anti-reflection (AR) glass and coatings are known. These may include those made by including a thin silica coating layer with a mesoporous structure on a substrate, such as flat or patterned glass. Those AR coated glasses may exhibit the features of tunable reflective index and thickness. But the mesoporous structure in the nanometer range may result in an increase of adsorption of pollutants from an outdoor environment, which in turn may cause an increase of refractive index and loss of transmittance.

Contamination on surface of anti-reflection (AR) glass may significantly diminish the performance of AR coated glass. For instance, the refractive index of SFO AR coated glass may increase from 1.246 to 1.303 within 28 days when AR coated glass is exposed to an outdoor environment. During this period, the transmittance gain of SR) AR coated glass (in terms of Tqe % gain, for example) may decrease from 2.7% to 1.77%. It is believed that almost 34% of Tqe % gain is dropped because of the contamination of AR coated glass.

Aside from the development of a barrier layer on pore surface to reduce contamination buildup, another strategy may be to integrate photo catalyst materials into an optical layer. This may play a role in decomposing organics adhered to surface pores by sunlight activation. Self-cleaning AR coated glass had been developed for this purpose, e.g., using sunlight (or other external source to cause decomposition of materials adsorbed to the surface of an AR coating). Among photocatalysts, titanium dioxide, TiO₂ is believed to be suitable for light-based decomposition, e.g., when in its anatase phase.

There may be two photo-induced phenomena created by TiO₂: the first is believed to be a photo-catalytic phenomena, which leads to the breakdown of organics; and the second is super-hydrophilicity, which leads to a high wetability.

A challenge of developing AR coated glass with the self-cleaning function by TiO₂ may be to keep a high transmittance because the refractive index of TiO₂ is generally quite high (sometimes around 2.4 or 2.5), which is higher than that of glass. Thus, the optical performance of AR coated glass may be reduced by a simple coating of a TiO₂ thin film layer on the glass's surface. Although the increase of pore size of TiO₂ thin layer may effectively reduce the refractive index of coating layer, the thin layer with weaker mechanical strength may reduce life time of AR coated glass.

Many prior efforts relate to either combination of TiO₂ and SiO₂ in same coating layer or different coating layers. For instance, one AR coated glass with both self-cleaning and super-hydrophilicity was developed by combining nanoparticles of TiO₂ and SiO₂ in one coating layer. The developed self-cleaning AR coated glass may exhibit good durability. In addition a simple spin coating process may be used.

The optical performances of self-cleaning AR coated glass may be evaluated by broadband transmittance, refractive index, and optical thickness. This application relates to an insight that balance between self-cleaning and optical performance may be achieved by adjusting the amount of TiO₂ nanoparticles in a coating layer.

In certain example embodiments, a method of making a coated article comprising an anti-reflection coating supported by a glass substrate is provided. At least a portion of a solution comprising (i) a metal alkoxide, (ii) a transition metal alkoxide, and (iii) titanium dioxide nanoparticles, is deposited on the glass substrate to form a substantially uniform coating. Said coating is cured and/or allowed to cure, in making the anti-reflection coating.

In certain example embodiments, a coated article comprising an anti-reflection coating supported by a glass substrate is provided. The anti-reflection coating comprising: a reaction product of a hydrolysis or a condensation reaction of a metal alkoxide and a transition metal alkoxide; and a plurality of anatase TiO₂ nanoparticles having a diameter or major distance size less than 100 nm, suspended in a matrix formed from the reaction product. The anti-reflection coating has a refractive index less than 1.5.

According to certain example embodiments, the metal alkoxide may comprise tetraethyl orthosilicate, and/or the transition metal alkoxide may comprise titanium n-butoxide.

According to certain example embodiments, the solution has a molar ratio of titania to silica in the range from 0.15 to 0.84.

According to certain example embodiments, the titanium dioxide nanoparticles may have a diameter or major distance size less than 100 nm, more preferably less than 75 nm, and still more preferably less than 50 nm, and possibly less than 10 nm.

These aspects, features, and example embodiments may be used separately and/or applied in various combinations to achieve yet further embodiments of this invention.

### BRIEF DESCRIPTION OF THE DRAWINGS

FIG. 1 is a transmission electron microscopy (TEM) image of TiO₂ nanoparticles in solution.

FIG. 2 shows an XRD pattern of titanium dioxide nanoparticles from a thin film of solution coated on glass.

FIG. 3 schematically illustrates a hydrolysis of Ti(OBu)₄ with acid as a catalyst.

FIG. 4 schematically illustrates condensation of hydrolyzed Ti(OBu)₄ by alcoxolation.

FIG. 5 schematically illustrates condensation of hydrolyzed Ti(OBu)₄ by olation.

FIG. 6 schematically illustrates a reaction between hydrolyzed Ti(OBu)₄ and TiO₂ nanoparticles.

FIG. 7 schematically illustrates hydrolysis of TEOS with an acid as a catalyst.

FIG. 8 schematically illustrates condensation of hydrolyzed TEOS with an acid as a catalyst.

FIG. 9 schematically illustrates reaction between hydrolyzed TEOS and SiO₂ elongated nanoparticles.

FIG. 10 schematically illustrates a self-cleaning anti-reflection coated article.

FIG. 11 depicts transmittance curves of certain self-cleaning AR coated glasses.

FIG. 12 includes SEM images of self-cleaning AR coated glass. A and B are cross-sectional images with low and high magnification; C and D are top surface titled at 45 degrees with low and high magnification.

FIG. 13 schematically illustrates a photocatalytic mechanism of TiO₂.

FIG. 14 illustrates UV absorption of methylene blue solution vs. wavelength as function of UV irradiation time.

FIG. 15 illustrates UV absorption of methylene blue solution vs. wavelength as function of UV irradiation time.

FIG. 16 illustrates UV absorption of methylene blue solution vs. wavelength as function of UV irradiation time.

FIG. 17 illustrates photocatalytic degradation of methylene blue vs. UV irritation time.

FIG. 18 illustrates UV irradiation time for different self-cleaning AR coated articles.

FIG. 19 illustrates water contact angles of self-cleaning AR coated articles with UV irradiation time.

FIG. 20 schematically illustrates schematically super-hydrophilic surface produced by self-cleaning antireflection coated articles.

FIG. 21 illustrates transmittance curves of self-cleaning AR coated articles measured from a repeatability test

FIG. 22 illustrates transmittance curves of self-cleaning AR coated articles measured from a repeatability test, and the labels are same as those in Table 7.

FIG. 23 shows AFM images of self-cleaning AR coated articles.

FIG. 24 illustrates the roughness of self-cleaning AR coated articles vs. molar ratio of TiO₂ to SiO₂.

FIG. 25 illustrates optical thickness and refractive index of self-cleaning AR coated articles with different molar ratios of TiO₂ to SiO₂ on coating layer.

### DETAILED DESCRIPTION OF EXAMPLE EMBODIMENTS

Self-cleaning anti-reflection (AR) solar float glass coated articles may be prepared by sol-gel process with sol containing elongated silica nanoparticles and spherical titanium dioxide nanoparticles. It is believed that a geometrical package of nanoparticles may include a porous structure of a thin film coating layer, by which anti-reflection glass may be produced.

In order to improve properties relating to the nanoparticles in the layer (e.g., to enhance the adhesive strength of nanoparticles), certain example embodiments envision the use of (i) metal alkoxides (such as tetraethyl orthosilicate (TEOS), tetramethyl orthosilicate (TMOS) or other suitable metal alkoxides) and (ii) transition metal alkoxides (such as titanium n-butoxide).

In an example aspect, the nanoparticles may have a size less than 100 nm, less than 75 nm, less than 50 nm, less than 25 nm, less than 10 nm, or less than 5 nm.

In certain embodiments, one or more suitable metal alkoxides may be used, such as tetraethyl orthosilicate (TEOS), tetramethyl orthosilicate (TMOS), tetraisopropoxysilane; tetrakis(dimethylsiloxyl)silane; tetrakis(butoxyethoxyethoxy) silane; tetarksi(ethoxyethoxy)silane; tetrakis(2-hydroxyethoxy)silane; tetrakis(methoxylethoxyethoxy)silane; tetrakis(methoxyethoxy)silane; tetrakis(trimethylsiloxy)silane; tetramethoxysilane; tetra-n-propoxysilane; trimethoxysilane; trimethoxysilane; triethoxfluorosilane; p-(triethoxysilyl)acetophenone; 3,3,3-trifluoropropyl)trimethoxysilane; trimethoxysilane; tris(dimethylsiloxy) ethoxysilane; vinyltris(dimethysiloxy)silane, or other metal alkoxides corresponding to the general formula M(OR)ₙ, where M corresponds to a metal or metalloid (such as Al, Ga, Ge, Si, etc.), where OR corresponds to an alkoxide of the generic formula OCₘH₂ₘ₊₁, and where n is any number greater than 0 and m is any integer greater than or equal to 0.

In certain example embodiments, one or more suitable transition metal alkoxides may be, for instance, titanium alkoxides, such as titanium isopropoxide, titanium n-butoxide (TBO), titanium tetraisobutoxide, titanium tetraisopropoxide, titanium tetraethoxide, methyltitanium triisopropoxide; pentamethylcyclopentadienyltitanium trimethoxide; penyltitanium triisopropoxide; titanium bis(triethanolamine)-diisopropoxide; titanium t-butoxide; titanium chloride triisopropoxide; titanium di-n-butoxide bis(2-ethylhexanoate); titanium dichloride diethoxide; titanium ethoxide. Other transition metal alkoxides may also be used, such as those corresponding to the general formula M(OR)ₙ, where M corresponds to a transition metal, where OR corresponds to an alkoxide of the generic formula OCₘH₂ₘ₊₁, and where n is any number greater than 0 and m is any integer greater than or equal to 0.

In an example aspect, the molar ratio of TiO₂ to SiO₂ in a suitable sol may be in the range from 0.05 to 1.00, 0.15 to 0.84, 0.10 to 0.90, 0.20 to 0.80, 0.3 to 0.7, 0.45 to 0.55. All sub-ranges of those molar ratios are also envisioned and possessed.

It is believed that a hydrolysis and condensation reaction of the metal alkoxide and transition metal alkoxide (e.g., of TEOS and titanium n-butoxide (TBO)) may generate a cross-linked network structure involving nanoparticles and condensed TEOS and TBO.

In certain embodiments, it may be possible to achieve a higher transmittance of AR coated glass with Tqe % gain from range of 1.3% to 2.8%, e.g., by obtaining a thin film with gradient refractive index. The refractive index of thin film coated on glass surface may be in the range of from 1.27 to 1.38, corresponding to optical thickness from 162 nm to 82 nm. Photo-catalysis of titanium dioxide may provide a self-cleaning performance, e.g., as shown by degradation of methylene blue and change of water contact angle during the irradiation of UV light. An increase of TiO₂ amount in coating layer may enhance self-cleaning performance of AR coated glass, but the transmittance of glass may decrease in some instances. Good or excellent durability evaluated by short term tests may be achieved for developed self-cleaning AR coated glass. Good repeatability of self-cleaning AR coated glass made by sol-gel process indicates that the developed procedure may be reliable.

In certain exemplary embodiments, the firing may occur in an oven at a temperature ranging preferably from 550 to 700° C. (and all sub-ranges therebetween), more preferably from 575 to 675° C. (and all sub-ranges therebetween), and even more preferably from 600 to 650° C. (and all sub-ranges therebetween). The firing may occur for a suitable length of time, such as between 1 and 10 minutes (and all sub-ranges therebetween) or between 3 and 7 minutes (and all sub-ranges therebetween).

In addition, the composition of the atmosphere's gas may be controlled during curing; that is, the curing may occur, for example, in an inert atmosphere of nitrogen and/or argon, or in an atmosphere or other suitable gas. Furthermore, partial curing is contemplated and included within the term “curing” and its variants.

Although the spin-coating method may be used for applying the sol to a substrate, the uncured coating may be deposited in any suitable manner, including, for example, roller-coating, spray-coating, flow-coating, dip-coating, curtain-coating and any other method of depositing the uncured coating on a substrate.

Similarly, any suitable heat-resistant substrate (such as any type of glass) may be used in certain example embodiments.

Several examples were prepared, so as to illustrate exemplary embodiments of the present invention.

Preparation of “Gen 1.5 Sol”

A colloidal solution (referred to herein as a “Gen. 1.5 sol”) with elongated SiO₂ nanoparticles and tetraethyl orthosilicate as a binder is prepared using the formulation in Table 1 below. The procedure includes the following steps: 69.714 g of n-propyl alcohol is placed into 200 ml of glass bottle with a Teflon stirring bar. Thereafter, 1.808 g of water, 3.637 g of tetraethyl orthosilicate and 19.951 g of solution with nano silica (SiO₂) particles are added, in that order. The solution is stirred after adding 4.89 g of AcOH and appeared cloudy, but no visible particles or precipitation are observed after aging 3 months.

TABLE 1
Formulation of Gen 1.5 Sol (SiO₂ Colloidal Solution)

| Chemicals | M.W. (g/mol) | Wt % | Mol ratio |
|---|---|---|---|
| n-propyl alcohol | 60.1 | 69.714 | 1.000 |
| Deionized water | 18 | 1.808 | 0.070 |
| Acetic acid (AcOH) | 60.05 | 4.890 | 0.056 |
| Tetraethyl orthosilicate | 208.33 | 3.637 | 0.012 |
| (TEOS) | | | |
| Silica nanoparticles | N/A | 19.951 | — |
| (*IPA-ST-UP) | | | |
| Total | — | 100 | — |

*IPA-ST-UP: elongated SiO2 particle; diameter: 40-100 nm; length: 9-5 nm; concentration: 15% in isopropanol

In the above formula for Gen 1.5 sol, the silica nanoparticles include about 15 wt % amorphous silica, 85 wt % isopropanol and less than about 1 wt % water. If elongated silica particles are used, they can range in diameter between 9-15 nm with an average length of 40-100 nm and with the OH group present in an amount of about 5-8 OH/nm². Water-based silica nanoparticles, such as SNOWTEX from Nissan Chemical, can also be used, with the size of silica nanoparticles ranging from 10-100 nm at a weight percentage of 20-40%.

In addition to elongated silica nanoparticles, spherical silica nanoparticles, such as those produced under the trade name ORGANOSILICASO (available from Nissan Chemical), can be used having a particle size of between 9-15/40-100 nm, a wt % SiO₂ of 15-16%, less than 1% water, a viscosity of less than 20 mPa·s and a specific gravity of between 0.85 and 0.90. The weight percentage of spherical silica nanoparticles in solution may range from 20-40%, which corresponds to 60-80% of solvent in the silica solution. Minor amounts of water in the range from 0.3 to 3 wt % may also be present in the final solution.

For Gen 1.5 sols such as those in Table 1, the amount of solid SiO₂ may be about 4 wt %. But the solid percentage can be from 0.6-10 wt %, with the amount of solvent comprising 70-97 wt %. The amount of tetraethyl orthosilicate (TEOS) used as a binder ranges from 0.3 to 20 mol %; the amount of acetic acid (which serves as a catalyst) may range from 0.01-7 mol %; and the molar ratio of water to silica ranges from 1.1 to 50.

Although acetic acid may be particularly mentioned, other acids or bases could be used. For example, the catalyst could be an inorganic acid, an organic acid, or an inorganic base. Inorganic acids may include, for example, hydrochloric acid, nitric acid, phosphoric acid, sulphuric acid, boric acid, hydrofluoric acid, hydrobromic acid, perchloric acid, etc. Organic acids may include, for example, lactic acid, formic acid, citric acid, oxalic acid, uric acid, etc. Inorganic bases may include, for example, ammonium carbonate, ammonium hydroxide, barium hydroxide, cesium hydroxide, magnesium hydroxide, potassium hydroxide, rubidium hydroxide, sodium hydroxide, etc.

A typical solvent used in the silica solution may include alcohol, such as isopropanol, methanol, n-propanol, and ethanol. Other solvents may include N,N-dimethyl acetamide, ethylene glycol, ethylene glycol mono-n-propyl ether, methyl ethyl ketone, ethylene oxide, formamide, dimethylformamide, acetonitrile, dioxane, tetrahydrofuran, 2-ethoxyethanol, 2,2′,2″-nitrilotriethanol, and methyl isobutyl ketone, Isopropanol is the recommended solvent for silica nanoparticles ranging in size from 10 to 100 nm.

Materials

Tetraethyl orthosilicate (MOS, available from Aldrich), N-propyl alcohol (NPA, available from Aldrich), acetic acid (AcOH, available from Fisher Scientific), elongated silica nanoparticle (IPA-ST-UP, 15% in IPA, available from Nissan Chemical) and titanium n-butoxide, (TBO, available from Gelest) were used without purification. De-ionized water with conductivity as 18 Ω/cm was used. Solar float glass (SFO, thickness of 3.2 mm) was obtained from Phoenicia America-Israel (owned by Guardian). SFO glass has tin and air sides, which can be recognized with short wavelength UV light (256 nm). Spherical TiO₂ nanoparticles with size as 40-50 nm and anatase structure are dispersed in IPA (9.6 wt. %, CCA-1, Cinkarna). The particle size of the titania nanoparticles is generally a diameter (or a major distance across the particle) with the assumption that the particles are believed to be approximately spherical.

It is noted that solar float glass typically includes a low iron content. High transmission, low iron glass that may be used in certain example embodiments may include, for example, U.S. Pat. Nos. 7,700,870; 7,557,053; and 5,030,594 and U.S. Publication Nos. 2006/0169316; 2006/0249199; 2007/0215205; 2009/0223252; 2010/0122728; 2009/0217978; and 2010/0255980, the entire contents of each of which are hereby incorporated herein by reference.

Preparation of Sols for Self-Cleaning AR Coated Glass

The sol for making self-cleaning AR coated articles was prepared by mixing 10 g of TBO into 30 g of NPA. The sol was stirred at room temperature for 24 hours. Then, 10 g of above sol was mixed with 0.5 g of CCA-1. The sol with TiO₂ nanoparticles was further mixed with Gen 1.5 sol with SiO₂ percentage as 4% and 5%, respectively, to generate the final sol for coating application. Sols with SiO₂ percentages of 4% and 5% were prepared by diluting Gen 1.5 (12 wt %) sol with NPA. A yellow color may be observed when mixing Gen 1.5 sol and sol with CCA-1.

Table 2 lists formulations of Gen 1.5 with SiO₂ percentage of 12 wt %. Tables 3 and 4 list the formulations of the final sol. Table 5 presents the molar ratio of SiO₂ to TiO₂ in a final sol, which may affect the performance of self-cleaning AR coated glass.

TABLE 2
Formulation of Gen 1.5 (12 wt %)*

| | M.W. | |
|---|---|---|
| Chem. | (g/mol) | wt., g |
| NPA | 60.100 | 24.201 |
| De-ion water | 18.000 | 1.556 |
| Acetic acid (AcOH) | 60.050 | 4.206 |
| Tetraethyl orthosilicate | 208.330 | 10.799 |
| (TEOS) | | |
| Nano silica particle (IPA-ST-UP)* | N/A | 59.239 |
| Total | | 100.000 |

*Amount of SiO₂ is calculated from silica nanoparticle and TEOS

TABLE 3
Formulations of sol made from Gen 1.5 (4%) and TiO₂ nanoparticle

| ID | Gen 1.5; 4% | TBO | NPA | CCA-1 | Total |
|---|---|---|---|---|---|
| | Wt (g) | | | | |
| Example 1 | 3.5 | 0.119 | 0.357 | 0.024 | 4 |
| Example 2 | 3 | 0.238 | 0.714 | 0.048 | 4 |
| Example 3 | 2 | 0.476 | 1.429 | 0.095 | 4 |
| | wt % | | | | |
| Example 1 | 87.5 | 2.976 | 8.929 | 0.595 | 100 |
| Example 2 | 75 | 5.952 | 17.857 | 1.190 | 100 |
| Example 3 | 50 | 11.905 | 35.714 | 2.381 | 100 |

TABLE 4
Formulations of sol made from Gen 1.5 (5%) and TiO₂ nanoparticle

| ID | Gen 1.5; 5% | TBO | NPA | CCA-1 | Total |
|---|---|---|---|---|---|
| | Wt (g) | | | | |
| Example 4 | 3.5 | 0.119 | 0.357 | 0.024 | 4 |
| Example 5 | 3.0 | 0.238 | 0.714 | 0.048 | 4 |
| Example 6 | 2.0 | 0.476 | 1.429 | 0.095 | 4 |
| | wt % | | | | |
| Example 4 | 87.5 | 2.976 | 8.929 | 0.595 | 100 |
| Example 5 | 75.0 | 5.952 | 17.857 | 1.190 | 100 |
| Example 6 | 50.0 | 11.905 | 35.714 | 2.381 | 100 |

TABLE 5
Composition of TiO₂ and SiO₂ in sol used for making
self-cleaning AR coated articles

| | | | | | | | | Mol. |
|---|---|---|---|---|---|---|---|---|
| | | | | | | | | ratio |
| | wt (g) | | | wt % | | Mol. | | TiO₂/ |
| ID | SiO₂ | TiO₂ | Total | SiO₂ | TiO₂ | SiO₂ | TiO₂ | SiO₂ |
| Example 1 | 0.140 | 0.028 | 0.168 | 3.5 | 0.699 | 0.0023 | 0.0003 | 0.150 |
| Example 2 | 0.120 | 0.056 | 0.176 | 3 | 1.397 | 0.0020 | 0.0007 | 0.350 |
| Example 3 | 0.080 | 0.112 | 0.192 | 2 | 2.794 | 0.0013 | 0.0014 | 1.051 |
| Example 4 | 0.175 | 0.028 | 0.203 | 4.375 | 0.699 | 0.0029 | 0.0003 | 0.120 |
| Example 5 | 0.150 | 0.056 | 0.206 | 3.75 | 1.397 | 0.0025 | 0.0007 | 0.280 |
| Example 6 | 0.100 | 0.112 | 0.212 | 2.5 | 2.794 | 0.0017 | 0.0014 | 0.841 |

Amount of SiO₂ is calculated from silica nanoparticle and amount of TEOS
Amount of TiO₂ is calculated from TiO₂ nanoparticle and amount of TBO

Preparation of Self-Cleaning AR Coated Glass

SFO glass (3″×3″) with a thickness of 3.2 mm was washed with soap, rinsed with de-ionized water, and dried with N₂ gas. A thin film of TiO₂ and SiO₂ nanoparticles was coated on SFO glass by spin coating with the sols presented in Tables 3 and 4. The spin coating speed was performed at 1300 rpm and a ramp of 255 rps. With the help of a pipette, 2 ml of sol was transferred to the tin side of SFO glass that was mounted in a sample stage of a spin coater. The spin coating time was set at 30 sec. The back side of coated glass was cleaned with tissue paper soaked with IPA after spin coating. Then, the coated glass was heated in a box furnace with 650° C. for 3.5 min. A solid coated layer was observed before heating, which indicates that partial condensation may occur during spin coating.

Characterization

UV-Vis Spectroscopy

Tqe % of raw glass and AR coated glass is measured by UV-Vis spectroscopy (PE-1050) from 400 to 1200 nm, and average Tqe % is calculated by following equation:

$$Tqe \% = \frac{{\sum }_{i = 400}^{1200} {( Tqe \% )}_{i}}{{\sum }_{i = 400}^{1200} {N}_{i}} \qquad ( 1 )$$

The transmission gain, ΔTqe % is calculated by subtracting Tqe % of raw glass from Tqe % of AR coated glass in the case of developed self-cleaning AR coated glass, as shown in Eq. (2); and subtracting from pre Tqe % of self-cleaning AR coated glass from post Tqe % of self-cleaning AR coated glass in the case of durability test as shown in Eq. (3).

ΔTqe %_{|Optica}=(Tqe %)_{AR}−(Tqe %)_{raw} (2)

ΔTqe %_{|Durability}=(Tqe %)_{psotAR}−(Tqe %)_{preAR} (3)

Water Contact Angle

Water contact angle of self-cleaning AR coated glass was measured with contact angle instrument (FTA 135) at room temperature. 10 g of methylene blue solution with concentration of 2×10⁻⁵ mol/l is added into one 100 ml glass beaker. One piece of self-cleaning AR coated glass with size as 20 mm×20 mm is immersed into solution and glass beaker is covered by one piece of quartz glass with thickness of 2 mm. The solution is irradiated with a UV lamp with a wavelength of 365 nm and power of 12.6 mW/cm². Water contact angle of self-cleaning AR coated glass is measured at different irradiation times. The AR coated glass is removed from solution and rinsed with de-ionized water and dried with N₂ gas before testing. One sessile drop of de-ionized water (˜2.3 d) is wetted on the surface of glass, and the water contact angle is immediately measured. The data is for the average values tested from three points on glass. The calculation of contact angle is performed by software (FTA, version 1.966).

Atomic Force Morphology (AFM)

The topography of self-cleaning AR coated glass is investigated by atomic force microscope (AFM, AP-0100, Parker Sci. Instrument). The non-contact method, preferred for soft surfaces in general, is used. The size of sample is about 2 cm×2 cm, and the scanning area is 5 μm×5 μm. The scanning rate is 0.5. The surface roughness is quantitatively characterized by measuring the arithmetic average roughness, Rₐ, and root mean square roughness, Rₘ. The definition of Rₐ and Rₘ is described in following equations.

$$\begin{matrix}{R}_{a} = \frac{1}{n} {\sum }_{i = 1}^{n} \vert {y}_{i} \vert & ( 4 ) \\ {R}_{m} = \sqrt{\frac{1}{n} {\sum }_{i = 1}^{n} {y}_{i}^{2}} & ( 5 )\end{matrix}$$

where yᵢ is the height of peak in AFM image.

XRD Analysis

A TiO₂ thin film is prepared by coating CCA-1 solution on SFO glass. The thin film is heated at box furnace at 200 C for 30 min. The phase structure of TiO2 thin film is characterized by X-ray diffraction (XRD, D8 advance, Bruker axs, CuKα). The scan rate is 1.2 degree/min and the scan range is from 20 degree to 65 degree.

Ellipsometer

Optical thickness and refractive index of self-cleaning AR coated glass are measured with an Ellipsometer (J. A. Woollam Co., HS-190). The refractive index of AR coated glass was reported at a reference wavelength of 550 nm. The complex reflectance ratio, ρ of a thin film is a function of ellipsometric factor of ψ and Δ. The fundamental equation of ellipsometry is described as follows:

ρ=tan ψe^{iΔ}=f(n1,n2,n,φ,d,λ,k) (6)

where n1, n2, and n represent the refractive index of air, substrate, and film, respectivity. Φ and λ represents the incident angle and wavelength of incident light, respectively. D and k are the thickness and extinction coefficient of thin films. In this study, the optical constants and thickness of glass substrate and thin film coating layer are kept constant. The relationship of ψ−λ and Δ−λ were fitted under incident angle of 75 degree after adjusting n, d, k. Fitting the optical constants of thin films with a Cauchy dispersion model described as follows:

$$n ( λ ) = A + \frac{B}{{λ}^{2}} + \frac{C}{{λ}^{4}} + … \qquad ( 7 )$$

Eq. (7) coordinates ellipsometric parameters to allow the determination of both thickness and optical constants for most transparent thin films. The mean square error (MSE) is a destination function to evaluate the quality of the match between measured and model calculated data. MSE could be described as follows:

$$MSE = \frac{1}{2 N - M} {\sum }_{i = 1}^{N} [ {( \frac{{ψ}_{i}^{mod} - {ψ}_{i}^{exp}}{{σ}_{ψ , i}^{exp}} )}^{2} + {( \frac{{Δ}_{i}^{mod} - {Δ}_{i}^{exp}}{{σ}_{Δ , i}^{exp}} )}^{2} ] \qquad ( 8 )$$

where Δ and ψ are the ellipsometric factors, superscript “mod” means the calculated data and superscript “exp” means the experimental data. N is the number of (ψ, Δ). M is the number of variable parameters. Σ is the standard mean square deviation.

Evaluation Self-Cleaning AR Coated Glass by Degradation of Methylene Blue

A series of methylene blue solutions with concentration from 5×10⁻⁷ to 2×10⁻⁵ mol/l are prepared by dissolving methylene blue into de-ionized water. The absorption of methylene blue solution is analyzed by UV-Vis spectroscopy (PE-900) from 200 to 800 nm. The maximum peak around 633 nm is used to plot standard curve. 10 g of methylene blue solution with concentration of 2×10⁻⁵ mol/l is added into one 100 ml glass beaker. One piece of self-cleaning AR coated glass with size as 25 mm×25 mm is immersed into solution and the glass beaker is covered with one piece of quartz glass with thickness of 2 mm. The solution was irradiated by a UV lamp with a wavelength of 365 nm and a power at 12.6 mW/cm². The concentration of methylene blue solution is analyzed at different times by UV-vis spectroscopy in order to evaluate the degradation of methylene blue.

Durability Test

Water Boil

The water boil test is performed as follows. The self-cleaning AR coated glass is immersed in one beaker filled with de-ionized water at 100° C. After 10 min, the AR coated glass is removed from boiling water and dried with N₂ gas before UV-vis measurement. The change of Tqe % is calculated as the difference of Tqe % before and after the water boil test. The water boil test is deemed acceptable when ΔTqe %<±0.5%.

NaOH Solution (0.1N)

The NaOH test is performed as follows. Self-cleaning AR coated glass was immersed in an NaOH solution (0.1 N) filled in one beaker at room temperature. After 1 hour, the glass is taken from the solution, rinsed with de-ionized water, and dried with N₂ gas. The change of Tqe % was calculated by the difference of Tqe % before and after NaOH test. The test is deemed acceptable when ΔTqe %<±0.5%.

Tape Pull

The tape pull test is performed as follows. The tape (3179C, available from 3M) is adhered to the surface of self-cleaning AR coated glass by pressing the tape with one's finger. After 1.5 minutes, the tape is pulled quickly by hand, and the residual adhesive of tape is removed with tissue paper (AccuWipe) soaked by NPA. The change of Tqe % is calculated by the difference of Tqe % before and after the tape pull test. The tape pull test is deemed acceptable when ΔTqe %<1.5%.

Crockmeter

The crockmeter test uses glass that is 3″×3″, and the total test cycle number is 750. The crockmeter test is deemed acceptable when ΔTqe %<1.5%.

Results and Discussion

TiO₂ Nanoparticles

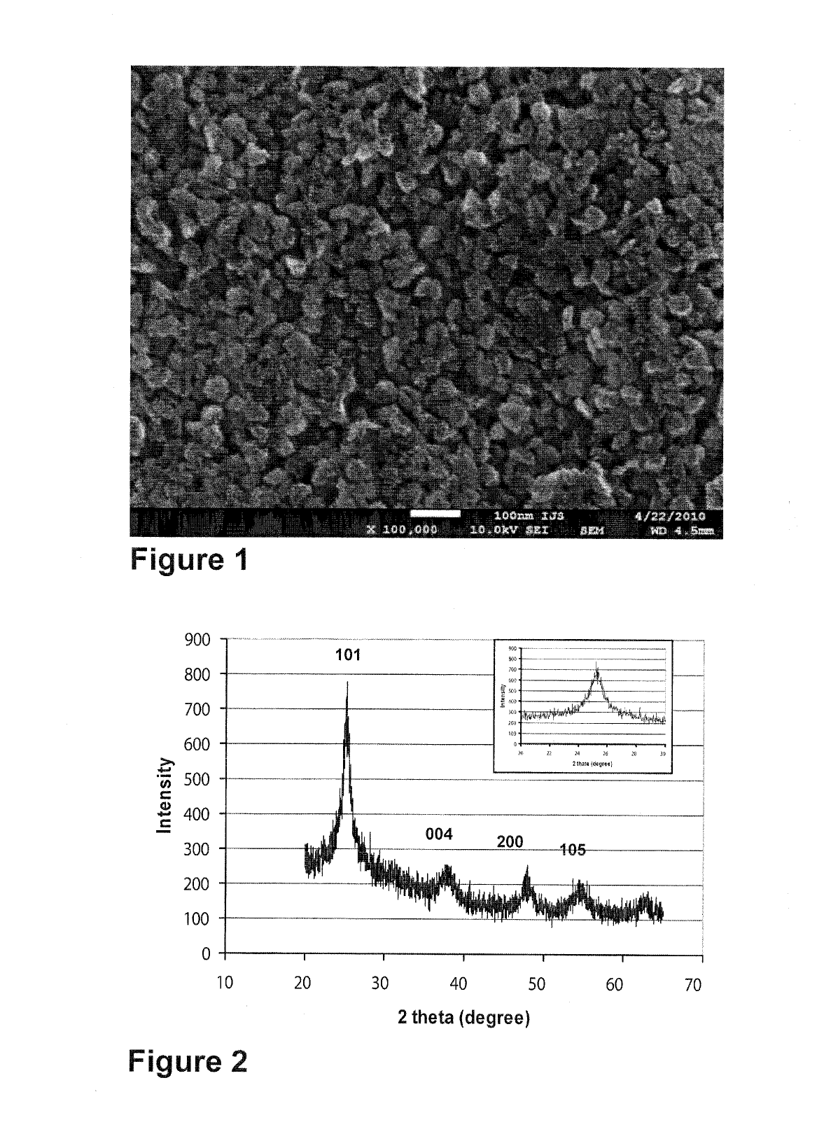

FIG. 1 is a transmission electron microscopy (TEM) image of TiO₂ nanoparticle in CCA-1 solution provided by Cinkarna. TiO₂ with anatase structure and size around 50 nm can be observed. The TEM picture of TiO₂ nanoparticles in the CCA-1 solution was provided by Cinkarna. FIG. 2 is an XRD pattern of TiO₂ nanoparticles coated on a glass surface; the thin film is heated at 200° C. for 30 min.

The XRD pattern indicates that there is one peak at 2 theta degree as 25.20°, which corresponds to the (101) reflection of the crystalline anatase phase. Other weak anatase peaks at 2 theta degree as 38°, 48° and 55° are also resolved.

The crystalline size of TiO₂ nanoparticle can be estimated by Scherrer equation described as follows:

$${B}_{size} ( 2 θ ) = \frac{K λ}{Lcon θ} \qquad ( 9 )$$

where K is Scherrer constant; L is the apparent size of crystalline domain (\acute{Å}); B is the full width half maximum; θ is scanning angle and is wavelength (\acute{Å}).

In order to examine a specific peak in detail, the intensity 2 theta around 20 to 30 degree is shown under magnification in the set of FIG. 2. TiO₂ nanoparticles are assumed to have generally spherical shapes; therefore, K is 0.89 and λ is 1.54 \acute{Å}. B is estimated as 1.3 degrees, then B=9.47 nm. The estimated crystalline size is smaller than the one observed by TEM. The difference could be explained from the assumption of the spherical shape. That is, it may be that TiO₂ nanoparticles are not an exact spherical shape as shown in TEM picture.

Formation of Cross-Linked Thin Film with SiO₂ and TiO₂ Nanoparticles

Several factors are believed to distinguish transition metal alkoxides from silicone alkoxides, which are frequently used as precursors in sol-gel related processes: First, the lower electronegativity of transition metals may enable them be more electrophilic reaction and thus less stable toward hydrolysis, condensation and other nucleophilic reactions. Secondly, transition metals may exhibit several stable coordinations, and when coordinatively unsaturated, they may be able to expand their coordination via olation, oxolation, alkoxy bridge, or other nucleophilic association mechanisms. For coordinatively saturated metal alkoxides in the absence of catalyst, both hydrolysis and condensation may occur by nucleophilic substitution (S_{N}) mechanisms involving nucleophilic addition (A_{N}) followed by proton transfer from the attacking molecule to an alkoxides or hydrogen-ligand within the transition state and removal of the protonated species as either alcohol (alcoxolation) or water (oxolation). Both the hydrolysis and condensation rates, and the structure of final products, can be impacted by an acid or base catalyst. For instance, acid can protonate negatively charged alkoxides group, by which the reaction kinetics may be enhanced as producing a good leaving group. Acid-catalyzed condensation may be directed preferentially toward the ends rather the middle of chains, resulting in a more extended, less highly branched cross-linked network.

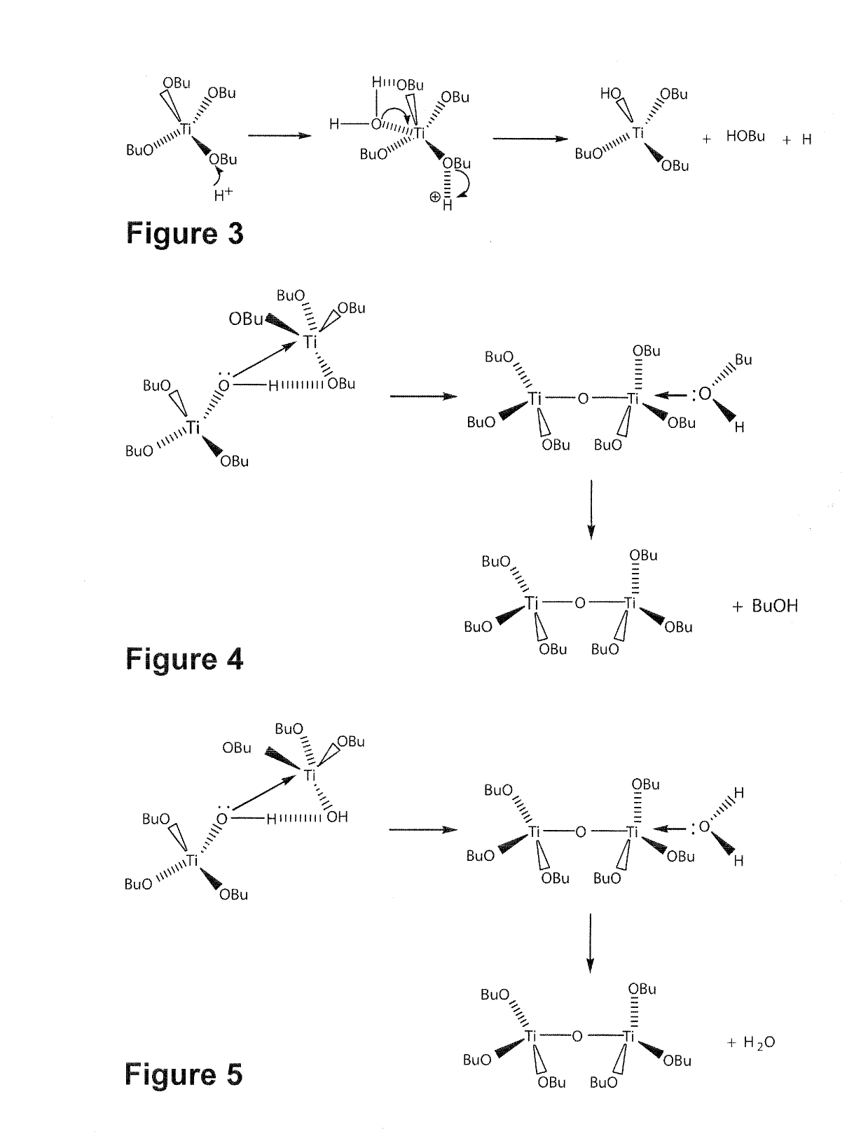

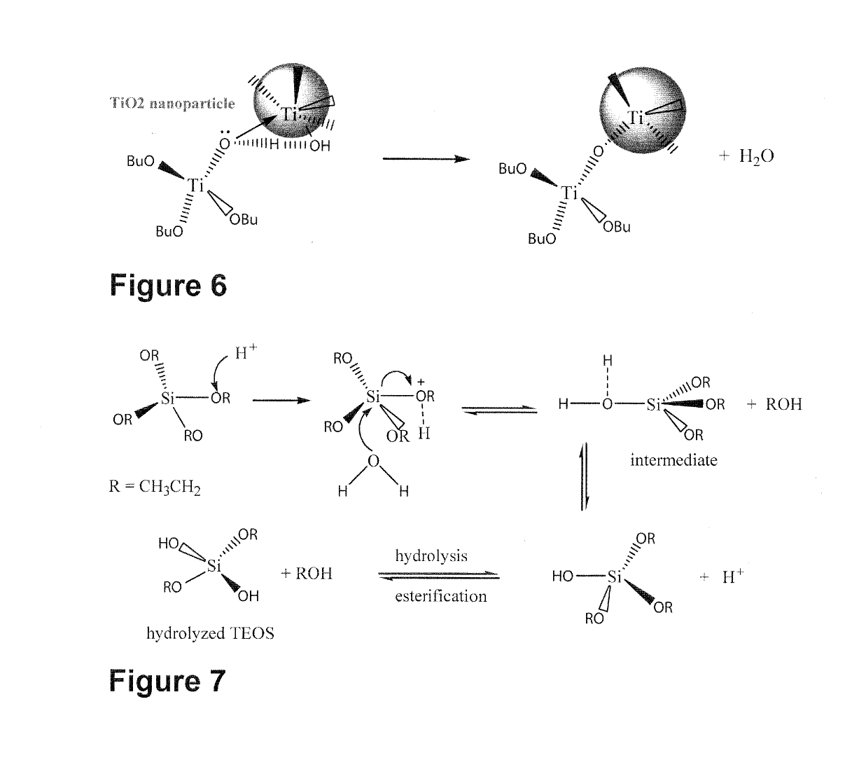

It is believed that TBO may be hydrolyzed with an acid catalyst as shown in FIG. 3. First, a n-butoxide group is activated by the attacking of one proton, by which electron density is shifted from titanium atom to oxygen atom. Then, one complex is generated by one water molecule and activated TBO. The leaving of HOBu group from complex results hydrolyzed Ti(OBu)₄. Hydrolized Ti(OBu)₄ can be further condensed by route of alcoxolation or olation as shown in FIGS. 4 and 5. In the way of alcoxolation, the complex is formed by hydrolyzed Ti(OBu)₄ and Ti(OBu)₄, and one BuOH molecule is produced as a by-product (see FIG. 4). Water as a by-product is generated among hydrolyzed Ti(OBu)₄ (see FIG. 5). Furthermore, hydrolyzed Ti(OBu)₄ may be attached with titanium dioxide nanoparticle as shown in FIG. 6. A three-dimensional cross-linked network may be developed, in which titanium dioxide nanoparticles act as the core bond with different hydrolyzed Ti(OBu)₄.

Meanwhile, TEOS may be hydrolyzed by SN₂ mechanisms in the presence of acid. FIG. 7 illustrates a process of TEOS hydrolysis with an acid as the catalyst. First, the electrophilicity of the Si atoms is enhanced by the attack of a proton, H⁺, released from acetic acid to the OR group of TEOS. The intermediate shown in FIG. 7 is generated by the reaction of water with an Si atom. The reaction intermediate produces the hydrolyzed TEOS and releases a proton, H⁺, which can be again used as the catalyst. This process may be repeated to generate various hydrolyzed TEOS, for example, silicic acid Si(OH)₄, as fully hydrolyzed TEOS. It is believed that the hydrolysis of TEOS may be a reversible reaction and esterification exists in the process.

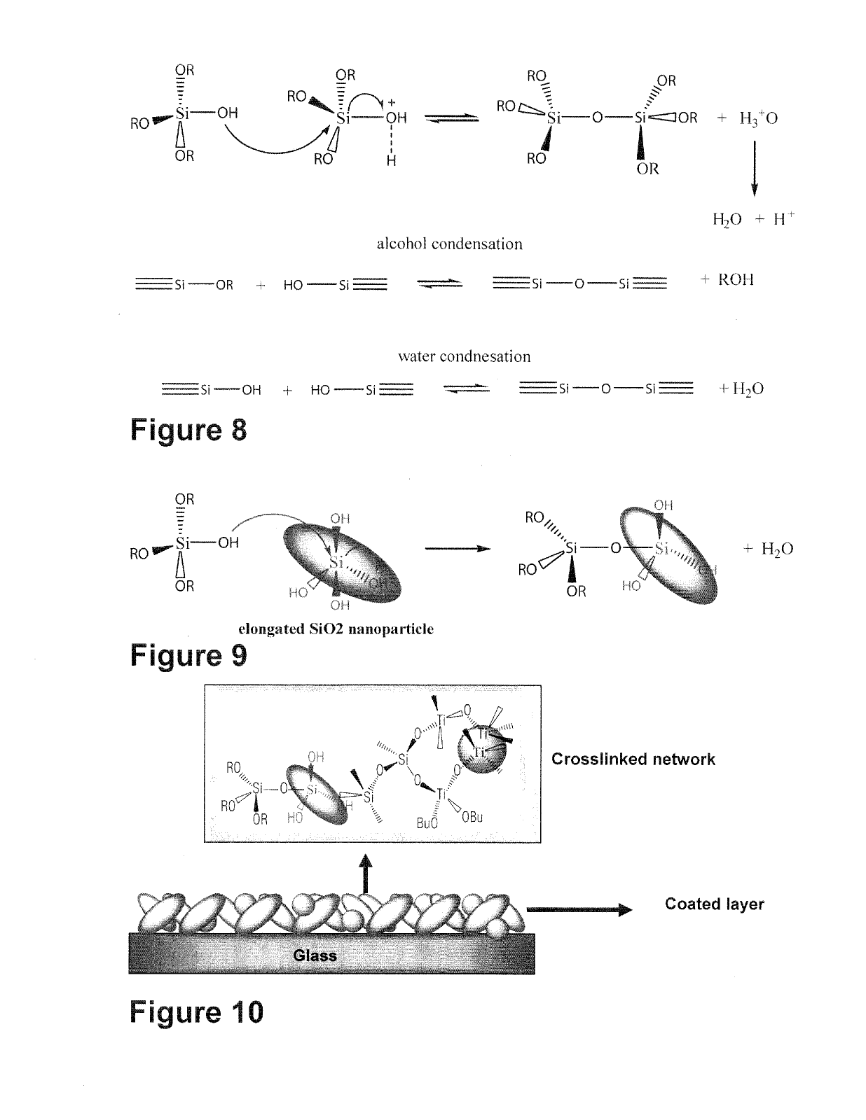

The hydrolyzed TEOS may be further condensed by route of water and alcohol condensation as shown in FIG. 8. The reversible reaction may be hydrolysis and alcoholysis, respectively. First, a proton will attack an oxygen atom in a hydroxyl group of a hydrolyzed alkoxysilane, which increases electrophilicity of an Si atom, and it is now easily attacked by a hydroxyl group from a hydrolyzed alkoxysilane molecule. One water molecule is released from intermediate and H₃⁺O is generated from water and a proton. A CH₃CH₂ group in TEOS worked as electron withdraw increases the acidity of the Si atom, which may consequently increase the condensation rate.

Hydrolyzed TEOS may also attack a silica nanoparticle with hydroxyl group on surface as shown in FIG. 9, by which the cross-linked network may be developed with nanoparticles as building materials and hydrolyzed TEOS as binder.

FIG. 10 schematically shows the structure of self-cleaning anti-reflection coated glass made by a sol-gel process, by which TiO₂ and SiO₂ nanoparticles are geometrically packaged on a glass surface and nanoparticles are connected by hydrolyzed TEOS and TBO.

Anti Reflection Coated Glass

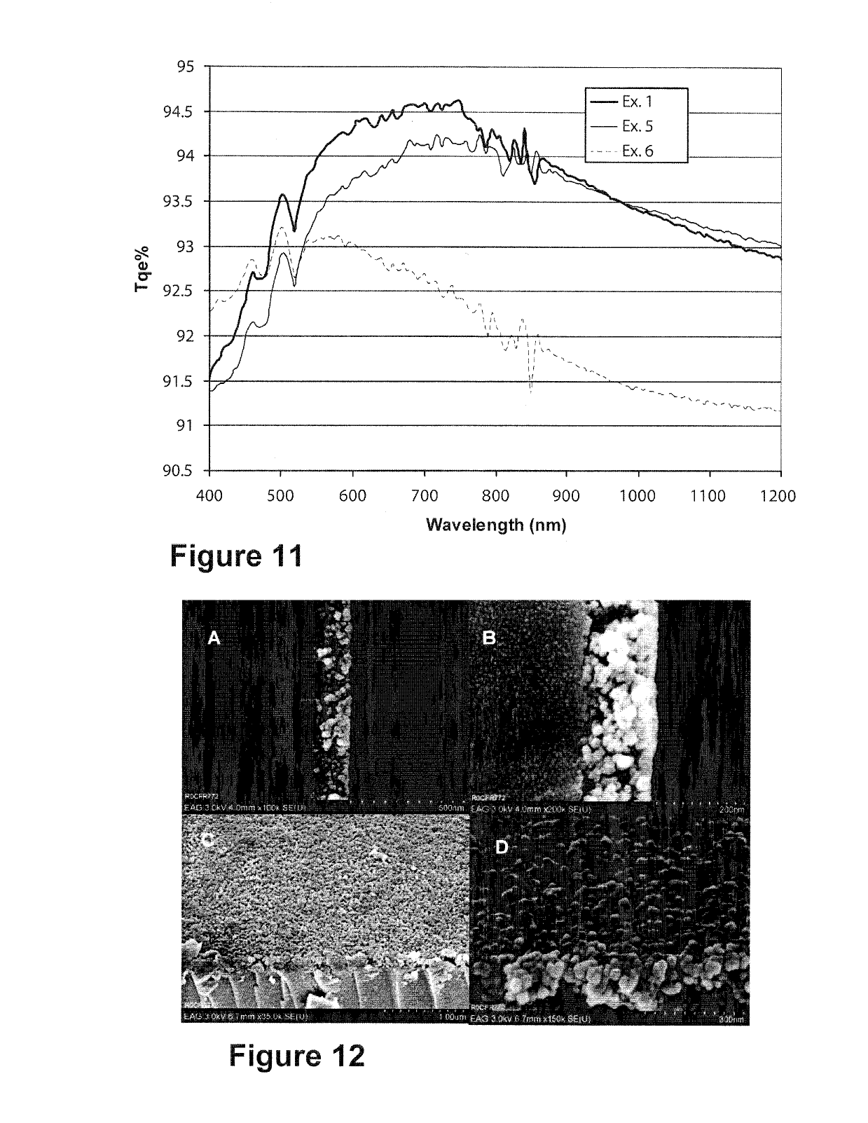

Table 6 lists transmittance. Tqe %, and Tqe % gain of different self-cleaning AR coated glasses made with different TiO₂ amounts. It is clear that there is a decrease on Tqe % gain of self-cleaning AR coated glass when the TiO₂ amount is increased in coating layer. FIG. 11 shows the transmittance curves of self-cleaning AR coated glass listed in Table 5. Typical transmittance curve and higher Tqe % gain demonstrate the performance of anti reflection.

TABLE 6
Tqe % gain of self-cleaning AR coated glass

| | | TiO₂ | Peak | Tqe % raw | Tqe % | |
|---|---|---|---|---|---|---|
| ID | Glass | wt. % | (nm) | glass | AR | Tqe % gain |
| Example 1 | SFO/Sn | 0.699 | 750 | 90.803 | 93.616 | 2.813 |
| Example 5 | SFO/Sn | 1.397 | 715 | 90.803 | 93.389 | 2.586 |
| Example 6 | SFO/Sn | 2.794 | 500 | 90.803 | 92.105 | 1.302 |

*The formulations are listed in Table 5.
**SFO glass and coated side is Tin side.

SEM Image of Self-Cleaning AR Coated Glass

FIG. 12 illustrates the morphologies of self-cleaning AR coated glass measured with SEM imaging. It is believed that there are many nano-dots on both cross-sectional and top surfaces, which are made by condensation of hydrolyzed TEOS and elongated silica nanoparticles. The pore structure exists in the thin film with denser structure on the top surface, and more pores can be seen at bottom of thin film. Fast evaporation of solvent, NPA, and alcohols generated during condensation may result in the formation of a denser top surface. A denser top surface may reduce the likelihood of further evaporation of solvent, which can be removed during the heating process. This may be why more pores can be found at the bottom of thin film. A rough thin film surface with tiny holes can be seen from top surface. The tiny holes may be generated by evaporation of solvent during heating process. Pore structure may be a critical factor to build an AR thin film, and a rough surface may improve hydrophilicity of surface.

Self-Cleaning Coated Glass

Titanium dioxide is believed to be an efficient common materials with photocatalytic properties, very high stability, and very low cost. It is believed that there are two major crystal structures in TiO₂, this is, anatase and rutile. Among them, anatase TiO₂ is believed to exhibit higher photocatalytic performance. The band gap of anatase type titanium dioxide is believed to be 3.2 eV, which is equivalent to a wavelength of 388 nm.

The absorption of ultraviolet rays shorter than this wavelength is believed to promote reactions. The absorption of photons is believed to delocalize a valence electron of TiO₂ and excite it to the conduction band of the semiconductor. These photo-excited charge carriers may initiate the degradation of the adsorbed chemical species by one or more forms of electron transfer reactions.

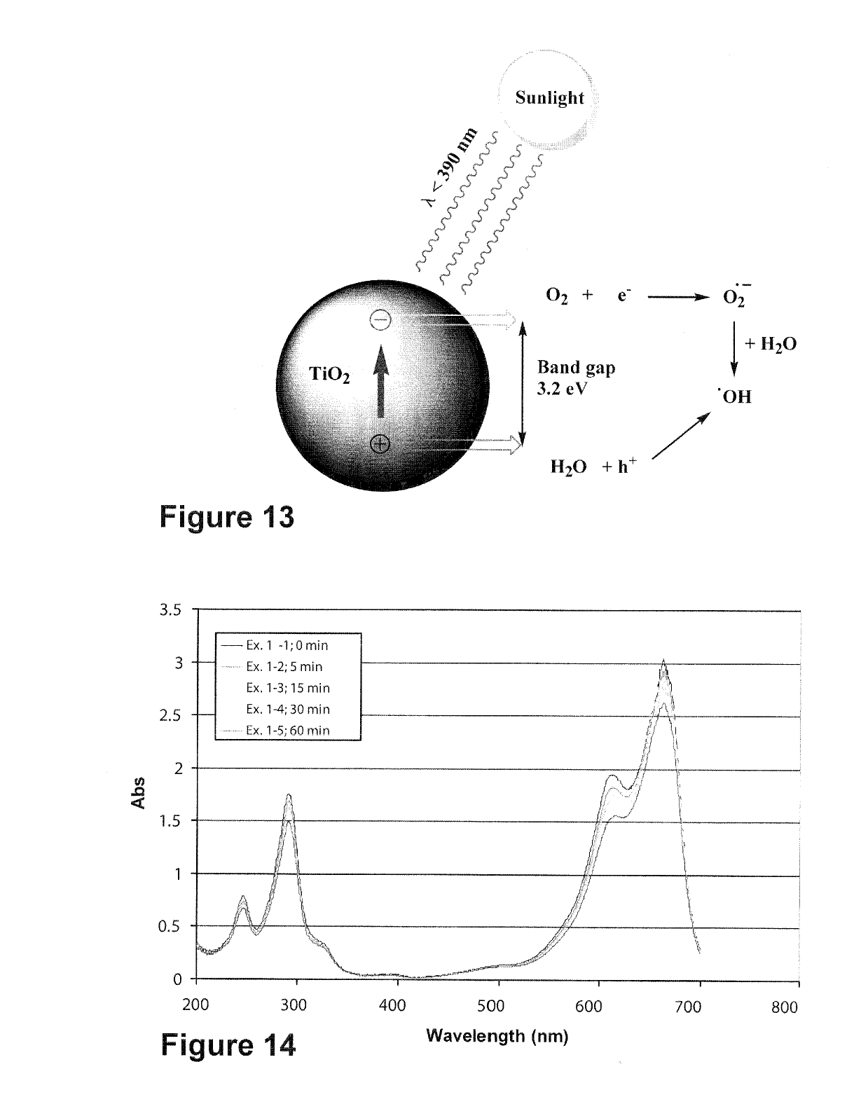

FIG. 13 illustrates a photo-catalysis mechanism. Photons are believed to be absorbed by TiO₂, and electron/hole pairs are generated. The surface of a photocatalyst contains water, which may be referred to as “absorbed water.” (In this case, the water remains on the surface and is not believed to enter the photocatalyst.) When contacting with absorbed water, this water believe to be oxidized by positive holes to form hydroxyl radicals (.OH), which have strong oxidative decomposing power. These free radicals may be able to oxide organic compounds to water and carbon dioxide. On the other hand, the reduction of oxygen by obtaining one electron excited in the conduction band results in the generation of superoxide anions (.O₂⁻). Superoxided anions may react with water to generate free radical .OH or attach to the intermediate product in the oxidative reaction, forming peroxide, which can further develop free radicals and decompose organic compounds.

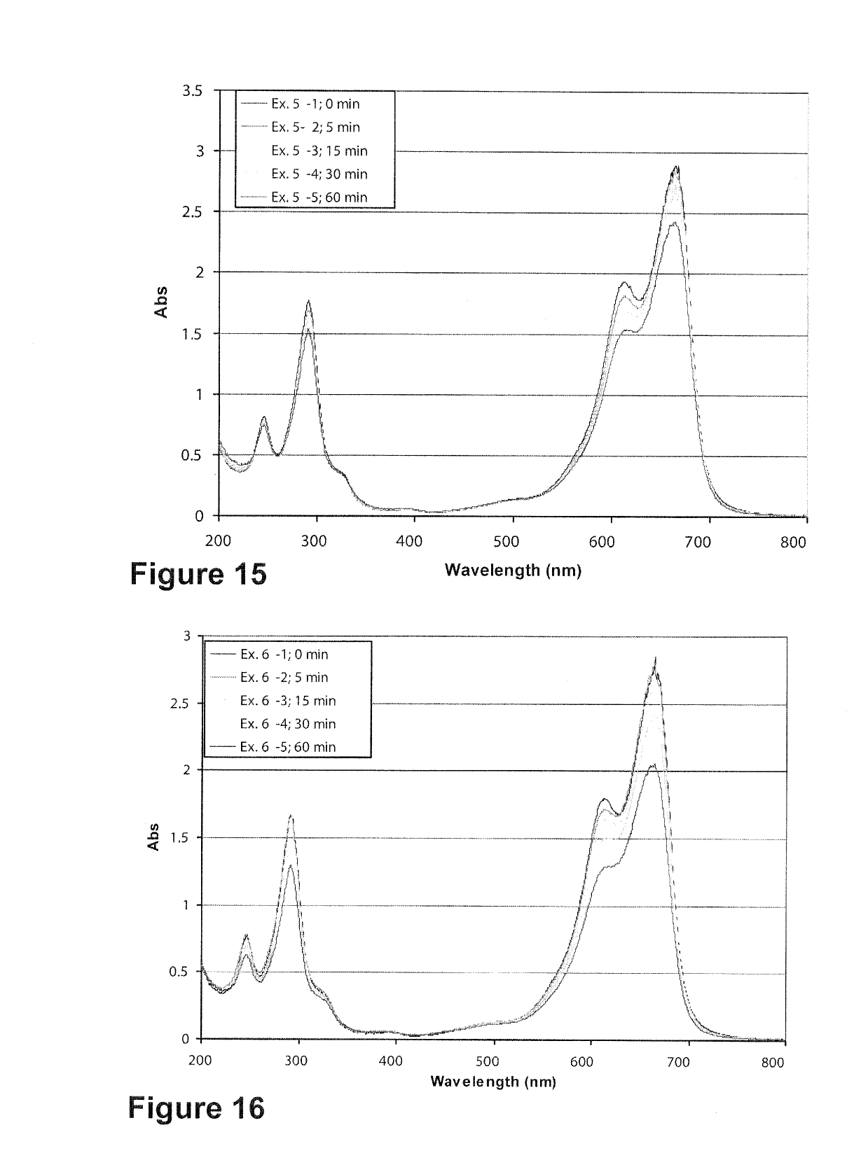

The self-cleaning AR coated glasses were immersed in methylene blue solution with a concentration of 2×10⁻⁵ mol/l, and absorption of methylene blue was monitored by UV-vis spectroscopy at different UV irradiation times. FIGS. 14, 15, and 16 show the profiles of UV-vis spectroscopes of methylene blue solution immersed with various self-cleaning AR coated glasses. These figures show that all self-cleaning AR coated glasses can degrade methylene blue as the absorption of methylene blue decreased with increasing UV irradiation time. More decay of methylene blue can be found with self-cleaning AR coated glass with more TiO₂ on coating layer.

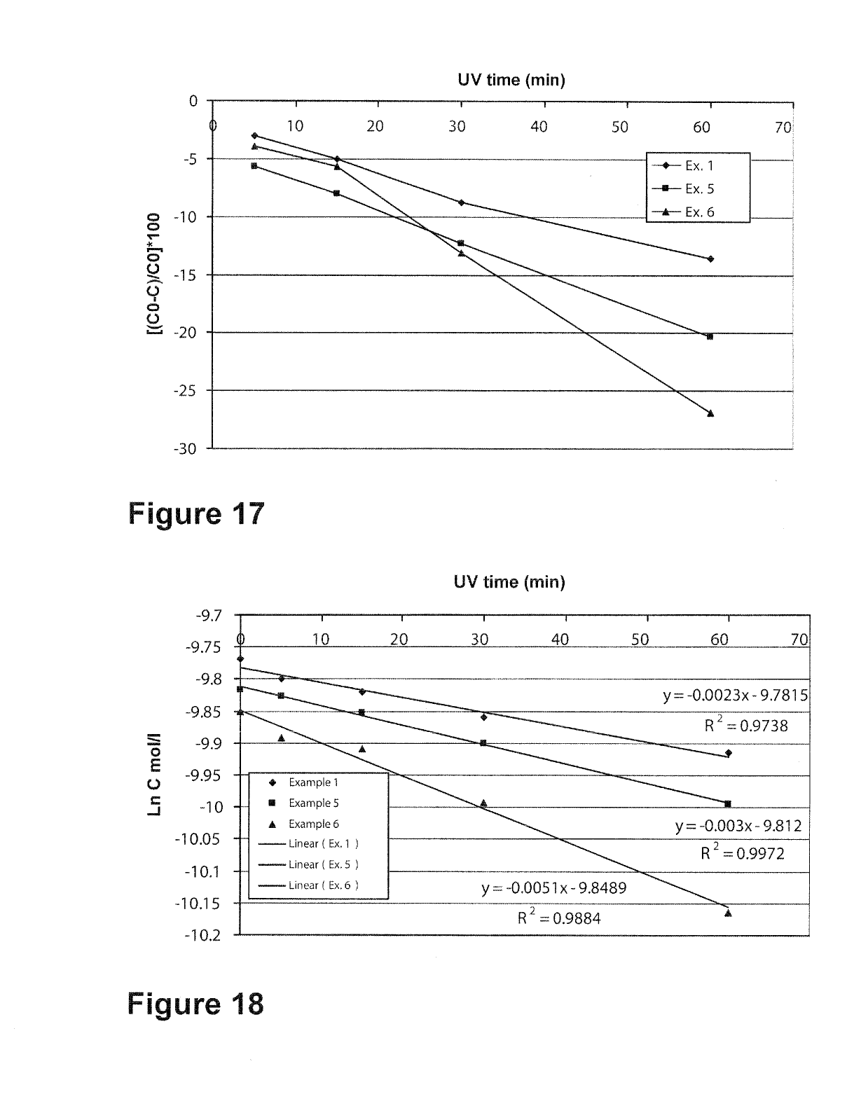

FIG. 17 shows the relationship between decomposition of methylene blue and UV time.

Degradation of methylene blue is observed with all self-cleaning AR coated glasses. The decomposition rate of methylene blue is increased with more TiO₂ on coating layer.

It is believed that photocatalysis experiments involving titanium thin films follows the Langmuir-Hinshelwood model, where the reaction rate, R is proportional to the surface coverage, Sc as described in Eq. (10)

$${S}_{c} = {n}_{m} \frac{bC}{1 + bC} \qquad ( 10 )$$

where nₘ is the number of moles of adsorbate corresponding to a monolayer and b is a parameter that is independent of pressure, P but depend upon T. The value of b depends upon the strength of the adsorbent-adsorbate interaction. Based on the first-order kinetics, the reaction rate R can be written as:

$$R = - \frac{d C}{d t} = {k}_{d} {S}_{c} = {k}_{d} {n}_{m} \frac{bC}{1 + bC} \qquad ( 11 )$$

Normally, the bC<<1, therefore Eq. (11) can be rewritten as follows:

$$- \frac{d C}{d t} = {k}_{d} {n}_{m} bC = {k}_{app} C \\ {k}_{app} = {k}_{d} {n}_{m} b \qquad ( 12 )$$

where kₐₚₚ is an apparent first order reaction rate constant. After integration of Eq. (12) and with initial concentration as C₀, Eq. (12) can be rewritten as follows:

$$- ln \frac{C}{{C}_{0}} = {k}_{app} t \qquad ( 13 )$$

FIG. 18 indicates that the decomposition of methylene blue follows the first-order reaction rate because of the good linear relationship between ln C and UV irradiation time. From the slope of a straight line, kₐₚₚ can be calculated as shown in Table 7. It is clear that the value of kₐₚₚ increases with the increasing of molar ratio of TiO₂ to SiO₂ on coating layer, which indicates that a major contribution of the decomposing of methylene blue is from TiO₂ nanoparticles.

TABLE 7
Apparent reaction rate constant, kₐₚₚ from different self-cleaning AR
coated glasses

| ID | molar ratio (TiO₂/SiO₂) | kₐₚₚ min⁻¹ |
|---|---|---|
| Example 1 | 0.150 | 0.0023 |
| Example 5 | 0.280 | 0.003 |
| Example 6 | 0.841 | 0.0051 |

Water Contact Angle

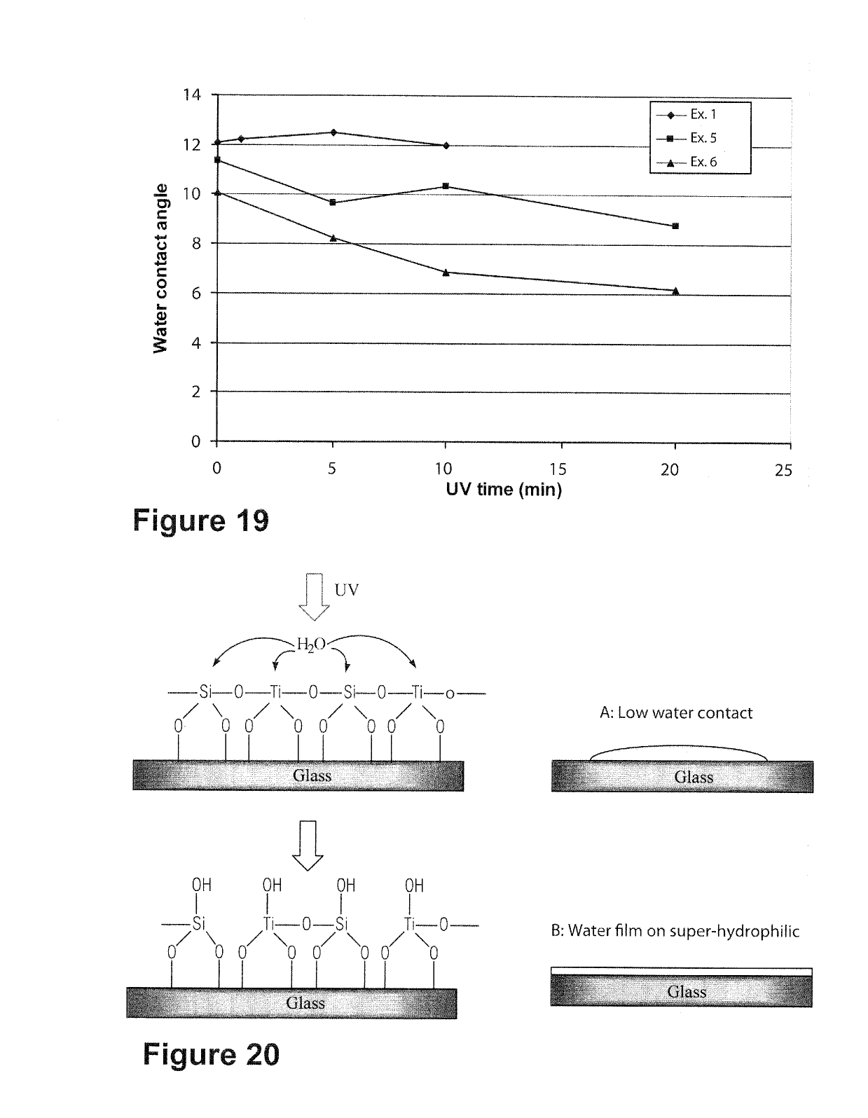

FIG. 19 illustrates the change of water contact angle of self-cleaning AR coated glass with UV irradiation time. It is clear that water contact angle decreased with increasing UV irradiation time, and lower contact angle can be observed for AR coated glass with more TiO₂ nanoparticle on the coating layer. Water contact angle is reduced from 10 degree to 6 degree with self-cleaning AR coated glass of 2.79 wt % TiO₂ in the coating layer. It appears that water contact angle before UV irradiation is the order with increased TiO₂ amount of coating layer. This phenomenon may be attributed to photocatalysts of TiO₂ by sunlight.

When the surface of photocatalytic film is exposed to UV light, the contact angle of the photocatalytic surface with water may be reduced gradually as more hydroxyl group is produced on surface. After enough exposure to light, the surface may reach a super-hydrophilic state. In other words, the surface may not repel water at all, so water cannot exist in the shape of a drop, but spreads flatly on the surface of the substrate, e.g., as illustrated in FIG. 20.

Repeatability Test

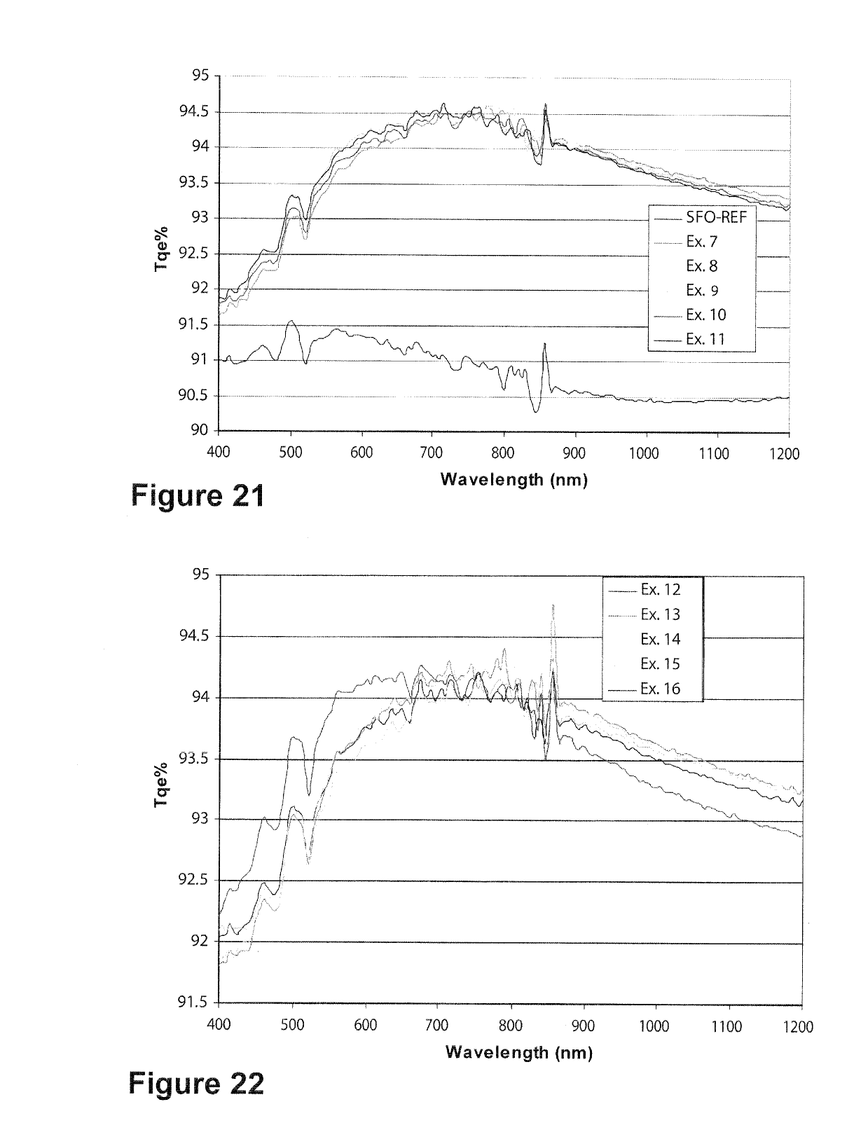

Table 8 lists Tqe % and Tqe % gain of self-cleaning AR coated glass during the repeatability test. Two groups of self-cleaning AR coated glass are prepared according to weight percentage of TiO₂ on coating layer. One was 0.699 wt. % of TiO₂, and another was 1.397 wt. % of TiO₂. Five samples of AR coated glass were prepared in each group. As listed in Table 8, for the first group, average Tqe % gain is 2.85% with standard variation as 0.028, and for the second group, average Tqe % gain as 2.67% with standard variation as 0.04. FIGS. 21 and 22 are the transmittance curves of self-cleaning AR coated glass presented in Table 8, respectively.

TABLE 8
Tqe % gain of self-cleaning AR coated glass during repeatability test

| | | | Peak | Tqe % raw | Tqe % | Tqe % | | |
|---|---|---|---|---|---|---|---|---|
| ID | Glass | TiO2 % | (nm) | glass | AR | gain | Ave. | STD |
| Example 7 | SFO/Sn | 0.699 | 780 | 90.836 | 93.654 | 2.819 | 2.847 | 0.028 |
| Example 8 | SFO/Sn | 0.699 | 755 | 90.836 | 93.715 | 2.880 | | |
| Example 9 | SFO/Sn | 0.699 | 810 | 90.836 | 93.705 | 2.869 | | |
| Example 10 | SFO/Sn | 0.699 | 755 | 90.836 | 93.654 | 2.818 | | |
| Example 11 | SFO/Sn | 0.699 | 715 | 90.836 | 93.686 | 2.850 | | |
| Example 12 | SFO/Sn | 1.397 | 755 | 90.836 | 93.465 | 2.630 | 2.667 | 0.040 |
| Example 13 | SFO/Sn | 1.397 | 790 | 90.836 | 93.534 | 2.699 | | |
| Example 14 | SFO/Sn | 1.397 | 805 | 90.836 | 93.538 | 2.702 | | |
| Example 15 | SFO/Sn | 1.397 | 785 | 90.836 | 93.454 | 2.618 | | |
| Example 16 | SFO/Sn | 1.397 | 680 | 90.836 | 93.523 | 2.688 | | |

SFO glass and coated side is Tin side.

Durability Test

Partial durability tests were evaluated, and the results are summarized in Table 9. Two self-cleaning AR coated glasses with percentage of TiO₂ as 0.699% and 1.397% were evaluated. All self-cleaning AR coated glasses passed water boiling, NaOH (0.1N), Tape pull and crockmeter tests. More durable self-cleaning AR coated glass might be attributed to the cross-linked network generated by metal alkoxides of TBO and TEOS with four functional groups and fast hydrolysis and condensation rates.

TABLE 9
Durability test of self-cleaning AR coated glass

| | | | | Peak | Tqe % | Tqe % | Tqe % |
|---|---|---|---|---|---|---|---|
| ID | Glass | Test item | TiO₂ % | (nm) | pre | post | gain |
| Example 7 | SFO/Sn | NaOH, 0.1N | 0.699 | 765 | 93.654 | 93.660 | 0.005 |
| Example 8 | SFO/Sn | Water boiling | 0.699 | 720 | 93.715 | 93.687 | −0.028 |
| Example 9 | SFO/Sn | Tape pull | 0.699 | 790 | 93.705 | 93.528 | −0.177 |
| Example 10 | SFO/Sn | Crockmeter | 0.699 | 765 | 93.654 | 92.885 | −0.768 |
| Example 12 | SFO/Sn | NaOH, 0.1N | 1.397 | 765 | 93.465 | 93.511 | 0.046 |
| Example 13 | SFO/Sn | Water boiling | 1.397 | 795 | 93.534 | 92.975 | −0.559 |
| Example 14 | SFO/Sn | Tape pull | 1.397 | 795 | 93.538 | 93.640 | 0.102 |
| Example 15 | SFO/Sn | Crockmeter | 1.397 | 810 | 93.454 | 92.933 | −0.521 |

AFM Images of Self-Cleaning AR Coated Glass

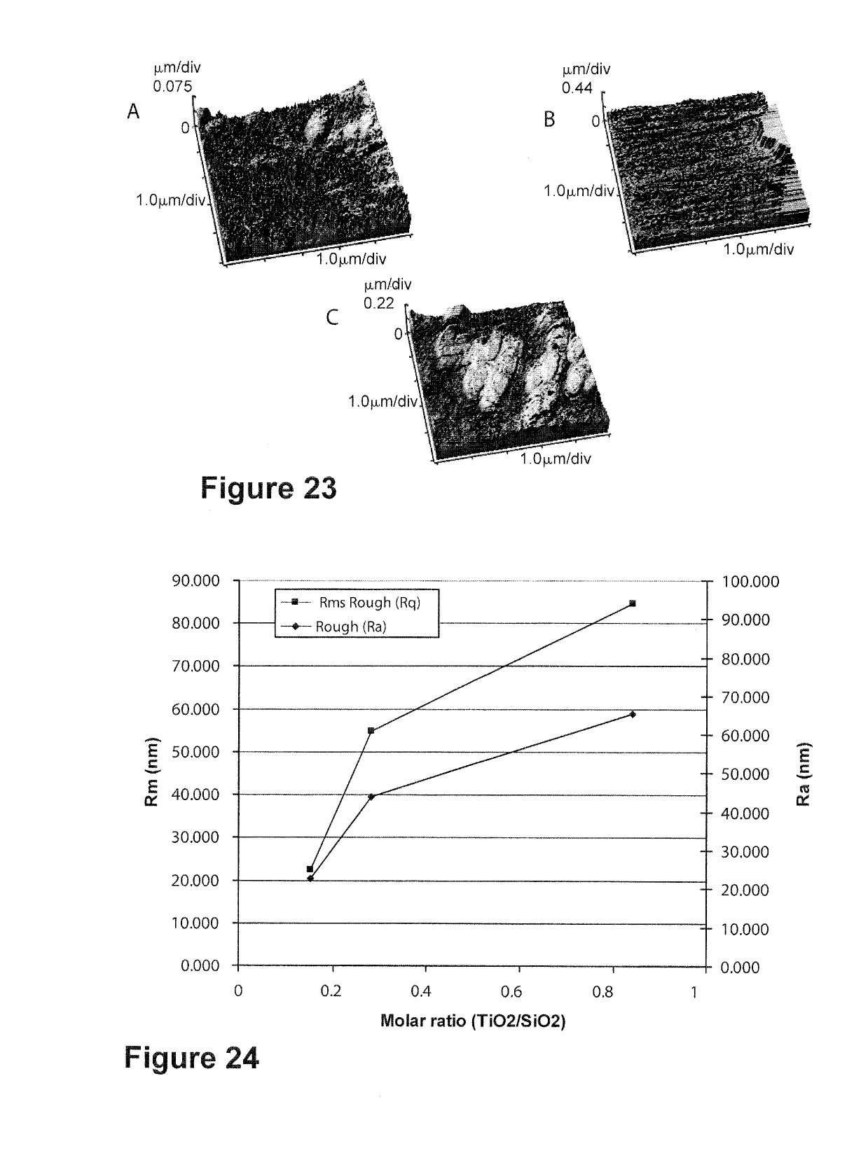

FIG. 23 shows the morphology of self-cleaning AR coated glass measured by AFM. The statistic roughness of self-cleaning AR coated glass is summarized in Table 10. It is believed that the surface roughness increased with increasing of TiO₂ amount on coating layer. FIG. 24 shows the relationship between Ra (Rm) and molar ratio of TiO₂ to SiO₂.

TABLE 10
Roughness of self-cleaning AR coated glass

| | Molar ratio | | | | |
|---|---|---|---|---|---|
| ID | (TiO2/SiO2) | Ra, nm | STD | Rm, nm | STD |
| Example 1 | 0.15 | 22.533 | 2.850 | 22.533 | 2.850 |
| Example 5 | 0.28 | 43.964 | 9.159 | 54.857 | 11.739 |
| Example 6 | 0.841 | 65.410 | 36.031 | 84.609 | 52.541 |

Optical Thickness and Refractive Index

Table 11 lists the optical thickness and refractive index of self-cleaning AR coated glass measured with an Ellipsometer. The optical thickness decreased, but the refractive index increased with increasing of molar ratio of TiO₂ to SiO₂ on coating layer. The increasing of refractive index might be attributed to the fact of higher refractive index of TiO₂. The decrease of thickness might be the reason there is a denser coating layer, instead of a porous structure when more TiO₂ is presented in the coating layer.

TABLE 11
Optical thickness and refractive index of self-cleaning AR coated glass

| | Molar ratio | | | |
|---|---|---|---|---|
| ID | (TiO2/SiO2) | MSE | thickness (nm) | R.I (550 nm) |
| Example 1 | 0.150 | 9.84 | 162.48 | 1.2742 |
| Example 5 | 0.280 | 8.73 | 154.42 | 1.3076 |
| Example 6 | 0.841 | 2.76 | 82.38 | 1.3826 |

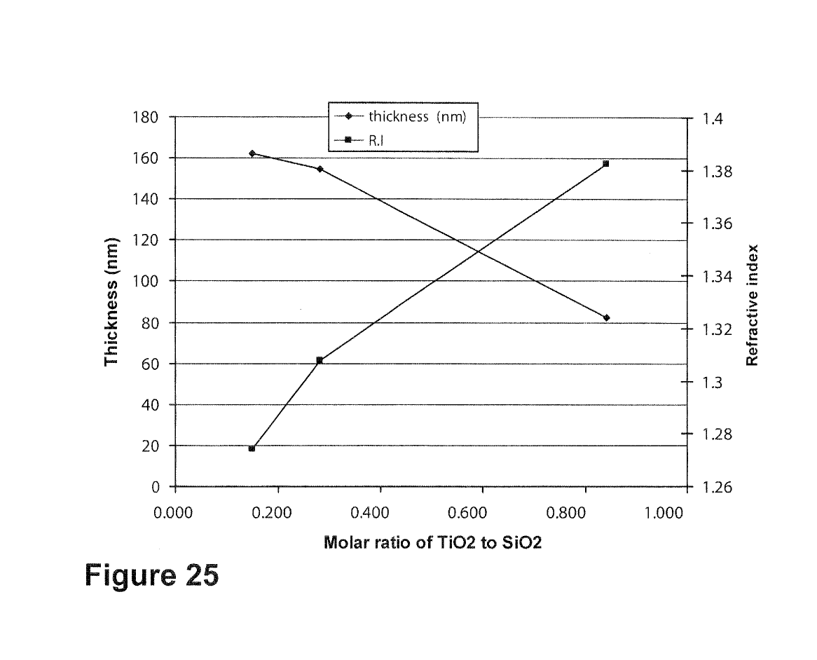

FIG. 25 shows the relationship between thickness, refractive index, and molar ratio of TiO₂ to SiO₂.

With sols containing silica and titanium nanoparticles, and TEOS and TBO as a binder, the self-cleaning glass may be prepared by a sol-gel process. Higher transmittance with Tqe % gain as high as 2.5-2.8% may be achieved in some cases. Self-cleaning performance may be evaluated by degradation of methylene blue and a change of water contact angle with UV irradiation. More than 30% of decrease on methylene blue concentration after 60 min of UV irradiation is believed to confirm the self-cleaning function. A decrease of water contact angle may also be achieved on a self-cleaning AR coated glass with UV irradiation. The increase of TiO₂ amount on coating layer may effectively increase self-cleaning performance, but a function of anti-reflection decreases. Certain example aspects of certain example embodiments relate to a self-cleaning AR coated glasses that can exhibit good durability, e.g., because they may pass water boiling, NaOH solution, tape pull and crockmeter tests.

The measurement of optical thickness and refractive index suggests the amount of TiO₂ may impact the structure of coating layer. A thinner coating layer with a higher refractive index may be expected when more TiO₂ is on coating layer. The roughness of self-cleaning AR coated glass appears to increase with more TiO₂ on coating layer.

As will be appreciated from the above, photocatalytic anatase TiO₂ may be provided in a matrix deposited in accordance with a sol gel technique. The incorporation of TiO₂ ordinary would be expected to increase the index of refraction, given the high index expected from TiO₂ based layers. However, certain example embodiments surprisingly and unexpectedly retain AR functionality, despite the introduction of a high index material. It is noted that durability is excellent, likely because of the composite material involved in certain example embodiments. For instance, TiO₂ and/or other elements may be provided at locations in the matrix that otherwise would be weak points

As used herein, the terms “on,” “supported by,” and the like should not be interpreted to mean that two elements are directly adjacent to one another unless explicitly stated. In other words, a first layer may be said to be “on” or “supported by” a second layer, even if there are one or more layers there between.

It will be appreciated that the nanoparticles of certain example embodiments will not be perfectly spherical in all scenarios. Thus, certain example embodiments report sizes as a diameter or major distance across the particle, which may be spherical, substantially spherical, slightly oblong, etc. In addition, although certain sizes are recited herein, it will be appreciated that those sizes are size distributions. In this sense, a “batch” of nanoparticles of a “size” may include nanoparticles sizes that are the same size or similar to the “size” reported. Preferably, the distribution will differ in size from what is reported by no more than 10%, more preferably no more than 5%, and still more preferably by no more than 3%.

In certain example embodiments, a method of making a coated article comprising an anti-reflection coating supported by a glass substrate is provided. At least a portion of a solution comprising (i) a metal alkoxide, (ii) a transition metal alkoxide, and (iii) titanium dioxide nanoparticles, is desposited on the glass substrate to form a substantially uniform coating. Said coating is cured and/or allowed to cure, in making the anti-reflection coating.

In addition to the features of the previous paragraph, in certain example embodiments, the metal alkoxide may comprise tetraethyl orthosilicate.

In addition to the features of either of the two previous paragraphs, in certain example embodiments, the transition metal alkoxide may comprise titanium n-butoxide.

In addition to the features of any of the three previous paragraphs, in certain example embodiments, the solution may comprise tetraethyl orthosilicates and titanium n-butoxide.

In addition to the features of any of the four previous paragraphs, in certain example embodiments, the titanium dioxide nanoparticles may have a major distance or diameter less than 100 nm, more preferably less than 75 nm, still more preferably less than 50 nm, and sometimes less than 10 nm.

In addition to the features of any of the five previous paragraphs, in certain example embodiments, the solution may contain titania and silica, and the solution may have a molar ratio of titania to silica in the range from 0.15 to 0.84.

In addition to the features of any of the six previous paragraphs, in certain example embodiments, the glass substrate may comprise solar float glass.

In addition to the features of any of the seven previous paragraphs, in certain example embodiments, the solution may be applied directly to the substrate using a spin coating method.

In addition to the features of any of the eight previous paragraphs, in certain example embodiments, the anti-reflection coating may have a refractive index less than 1.5.

In certain example embodiments, a coated article comprising an anti-reflection coating supported by a glass substrate is provided. The anti-reflection coating comprises a reaction product of a hydrolysis or a condensation reaction of a metal alkoxide and a transition metal alkoxide; and a plurality of anatase TiO₂ nanoparticles having a major distance or diameter less than 100 nm, suspended in a matrix formed from the reaction product. The anti-reflection coating has a refractive index less than 1.5.

In addition to the features of the previous paragraph, in certain example embodiments, the metal alkoxide may comprise tetraethyl orthosilicate.

In addition to the features of either of the two previous paragraphs, in certain example embodiments, the transition metal alkoxide may comprise titanium n-butoxide.

In addition to the features of any of the three previous paragraphs, in certain example embodiments, the solution may comprise tetraethyl orthosilicates and titanium n-butoxide.

In addition to the features of any of the four previous paragraphs, in certain example embodiments, the titanium dioxide nanoparticles may have a major distance or diameter less than 100 nm, more preferably less than 50 nm, and sometimes less than 10 nm.

In addition to the features of any of the five previous paragraphs, in certain example embodiments, the coating may contain titania and silica, and the coating may have a molar ratio of titania to silica in the range from 0.15 to 0.84.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a coated article comprising an anti-reflection coating supported by a glass substrate, the method comprising:
depositing on the glass substrate at least a portion of a solution comprising (i) a metal alkoxide, (ii) a transition metal alkoxide, and (iii) titanium dioxide nanoparticles, to form a substantially uniform coating; and
curing said coating and/or allowing said coating to cure, in making the anti-reflection coating.

2. The method according to claim 1, wherein the metal alkoxide comprises tetraethyl orthosilicate.

3. The method according to claim 1, wherein the transition metal alkoxide comprises titanium n-butoxide.

4. The method according to claim 1, wherein the solution comprises tetraethyl orthosilicates and titanium n-butoxide.

5. The method according to claim 1, wherein the titanium dioxide nanoparticles have a major distance or diameter less than 100 nm.

6. The method according to claim 1, wherein the titanium dioxide nanoparticles have a major distance or diameter less than 75 nm.

7. The method according to claim 1, wherein the titanium dioxide nanoparticles have a major distance or diameter less than 50 nm.

8. The method according to claim 1, wherein the titanium dioxide nanoparticles have a major distance or diameter less than 10 nm.

9. The method according to claim 1, wherein the solution contains titania and silica, and wherein the solution has a molar ratio of titania to silica in the range from 0.15 to 0.84.

10. A method according to claim 1, wherein the glass substrate comprises solar float glass.

11. A method according to claim 1, wherein the solution is applied directly to the substrate using a spin coating method.

12. A method according to claim 1, wherein the anti-reflection coating has a refractive index less than 1.5.

13. A coated article comprising an anti-reflection coating supported by a glass substrate, the anti-reflection coating comprising:
a reaction product of a hydrolysis or a condensation reaction of a metal alkoxide and a transition metal alkoxide; and
a plurality of anatase TiO₂ nanoparticles having a major distance or diameter less than 100 nm, suspended in a matrix formed from the reaction product,
wherein the anti-reflection coating has a refractive index less than 1.5.

14. A coated article according to claim 13, wherein the metal alkoxide comprises tetraethyl orthosilicate.

15. A coated article according to claim 13, wherein the transition metal alkoxide comprises titanium n-butoxide.

16. A coated article according to claim 13, wherein the solution comprises tetraethyl orthosilicates and titanium n-butoxide.

17. A coated article according to claim 13, wherein the titanium dioxide nanoparticles have a major distance or diameter less than 100 nm.

18. A coated article according to claim 13, wherein the titanium dioxide nanoparticles have a major distance or diameter less than 50 nm.

19. A coated article according to claim 13, wherein the titanium dioxide nanoparticles have a major distance or diameter less than 10 nm.

20. A coated article according to claim 13, wherein the coating contains titania and silica, and wherein the coating has a molar ratio of titania to silica in the range from 0.15 to 0.84.
